(19) United States
(12) Patent Application Publication
(10) Pub. No.: US 2006/0182178 A1
(43) Pub. Date: Aug. 17, 2006

(54) Moving picture data transmission apparatus

(76) Inventors: Kenji Oi, Tokyo (JP); Kazuaki Okamoto, Matsudo-shi (JP); Hideo Hirono, Narashino-shi (JP)

Correspondence Address: MCDERMOTT WILL & EMERY LLP, 600 13TH STREET, N.W., WASHINGTON, DC, 20005-3096, US

(21) Appl. No.: 11/339,829

(22) Filed: Jan. 26, 2006

(30) Foreign Application Priority Data
Jan. 26, 2005 (JP) P2005-018945
Jan. 25, 2006 (JP) P2006-016949

(51) Int. Cl. H04N 11/02; H04N 11/04; H04N 7/12; H04B 1/66

(52) U.S. Cl. 375/240.16; 375/240.24

(57) ABSTRACT

A moving picture data transmission apparatus according to the present invention includes: a weight assigner which assigns a weight to a macroblock on a first picture frame in accordance with the ratio of an overlap region where a reference picture block overlaps the macroblock on a picture frame; and a transmission method controller which controls a transmission method of the macroblock based on the weight assigned by the weight assigner.

### CROSS-REFERENCE TO RELATED APPLICATIONS

This application is based on and claims the benefit of priority from the prior Japanese Patent Applications No. P2005-18945, filed on Jan. 26, 2005 and P2006-16949, filed on Jan. 25, 2006; the entire contents of which are incorporated herein by reference.

### BACKGROUND OF THE INVENTION

1. Field of the Invention

The present invention relates to a moving picture data transmission apparatus and a moving picture data transmission method transmitting moving picture data. Particularly, the present invention relates to a moving picture data transmission apparatus and a moving picture data transmission method, in which important parts in the moving picture data involving motion on a screen can be transmitted with higher reliability.

2. Description of the Related Art

In a moving picture communication using a moving picture coding method such as MPEG, it is known in general that a processing load becomes higher as compared with processing loads in a normal data communication and a voice communication.

Consequently, for the purpose of reducing a delay in moving picture data transmission (processing) which results from such a high processing load, various methods have been proposed and realized.

For example, there has been disclosed a method of reducing the delay in moving picture data transmission by generating header information of moving picture data in macroblock units earlier than the moving picture data having been coded according to MPEG-4/FGS (Fine Granularity Scalability) (for example, Japanese Patent Application Laid-open Official Gazette 2004-343511 (pp. 11 to 13 and FIG. 3)).

### SUMMARY OF THE INVENTION

Particularly, in moving picture data, there are included “important parts” involving motion on a screen (on a picture frame) and desirable to be reliably transmitted to a transmission destination, and the other parts than the important parts.

However, in the abovementioned conventional method, macroblocks containing the important parts and macroblocks containing the other parts than the important parts are treated in the same manner. Accordingly, there has been a problem that the macroblocks containing the important parts cannot be transmitted in a method whereby they are discriminated from the other macroblocks.

That is, in the abovementioned conventional method, there has been a problem that the macroblocks containing the important parts cannot be transmitted with higher reliability ensured by treating the macroblocks containing the important parts differently from the other macroblocks (for example, transmitting macroblocks containing the important parts more than once).

The present invention was made in consideration of the above described situation, and is intended to provide a moving picture data transmission apparatus whereby the macroblocks containing the important parts can be transmitted with higher reliability.

For the purpose of solving the abovementioned problem, the present invention includes the following aspects. A first aspect of the present invention is defined as a moving picture data transmission apparatus including: a motion vector calculator configured to calculate a motion vector of a backward macroblock based on positions of a reference picture element on a first picture frame and of the backward macroblock containing the reference picture element on a second picture frame reproduced after the first picture frame; a reference picture block determiner configured to determine a reference picture block which is a region on the first picture and containing the reference picture element and based on the motion vector calculated by the motion vector calculator; a weight assigner configured to assign a weight to a macroblock on the first picture frame in accordance with the ratio of an overlap region where the reference picture block overlaps the macroblock on a picture frame; and a transmission method controller configured to control a transmission method of the macroblock based on the weight assigned by the weight assigner.

According to the aspect, the weight is assigned to the macroblock in accordance with the ratio of the overlap region where the reference picture block overlaps the macroblock on the picture frame. Furthermore, based on the weight assigned to the macroblock, the transmission method controller controls a transmission method of the macroblock, that is, for example, transmits the macroblock more than once if the weight assigned thereto exceeds a predetermined threshold value. Therefore, the macroblocks containing important parts can be transmitted with higher reliability.

A second aspect of the present invention relates to the first aspect of the invention, and a summary thereof is that the weight assigner assigns the ratio of the overlap region to a region occupied by the macroblock as the weight.

A third aspect of the present invention relates to the first aspect of the invention, and a summary thereof is that the weight assigner determines the weight assigned to the macroblock by using a plurality of the reference picture blocks determined by the reference picture block determiner.

A fourth aspect of the present invention relates to the first aspect of the invention, and a summary thereof is that the transmission method controller transmits the macroblock toward a transmission destination more than once if a value of the weight exceeds a predetermined threshold value.

A fifth aspect of the present invention relates to the first aspect of the invention, and a summary thereof is that the transmission method controller transmits a packet toward a transmission destination more than once if a sum of the weights assigned to a plurality of the macroblocks contained in the packet to be transmitted exceeds a predetermined threshold value.

A sixth aspect of the present intention relates to the first aspect of the invention, and a summary thereof is that the transmission method controller generates a packet so as to limit a sum of the weights assigned to a plurality of the macroblocks contained in the packet to be transmitted within a predetermined range.

A seventh aspect of the present invention relates to the first aspect of the intention, and a summary thereof is that the transmission method controller discards the macroblock if the weight assigned to the macroblock is lower than a predetermined threshold value.

An eighth aspect of the present invention is defined as a moving picture data transmission method including the steps of: calculating a motion vector of a backward macroblock based on positions of a reference picture element on a first picture frame and of the backward macroblock containing the reference picture element on a second picture frame reproduced after the first picture frame; determining a reference picture block which is a region on the first picture and containing the reference picture element based on the motion vector calculated by the motion vector calculator: assigning a weight to a macroblock on the first picture frame in accordance with the ratio of an overlap region where the reference picture block overlaps the macroblock on a picture frame; and, controlling a transmission method of the macroblock based on the weight assigned in the step of assigning the weight.

A ninth aspect of the present invention relates to the eighth aspect of the invention, and a summary thereof is that, in the step of assigning a weight, the ratio of an overlap region to a region occupied by the macroblock is assigned as the weight the overlap region being a region where the reference picture block overlaps the macroblock on the picture frame.

A tenth aspect of the present invention relates to the eighth aspect of the invention, and a summary thereof is that, in the step of assigning a weight, the weight assigned to the macroblock is determined by using a plurality of the reference picture blocks determined in the step of determining the reference picture block.

An eleventh aspect of the present invention relates to the eighth aspect of the invention, and a summary thereof is that, the macroblock is transmitted toward a transmission destination more than once in the step of controlling a transmission method if a value of the weight exceeds a predetermined threshold value.

A twelfth aspect of the present invention relates to the eighth aspect of the invention, and a summary thereof is that, a packet is transmitted toward a transmission destination more than once in the step of controlling a transmission method if a sum of the weights assigned to a plurality of the macroblocks contained in the packet to be transmitted exceeds a predetermined threshold value.

A thirteenth aspect of the present invention relates to the eighth aspect of the invention, and a summary thereof is that, in the step of controlling a transmission method, a packet is generated so as to limit a sum of the weights assigned to a plurality of the macroblocks contained in the packet to be transmitted within a predetermined range.

A fourteenth aspect of the present invention relates to the eighth aspect of the invention, and a summary thereof is that, in the step of controlling a transmission method, the macroblock is discarded if the weight assigned to the macroblock is lower than a predetermined threshold value.

A fifteen aspect of the present invention relates to the first aspect of the invention, and the moving picture data transmission apparatus further includes an importance transmitter configured to transmit a macroblock importance indicating the weights assigned to the macroblocks to a destination.

A sixteen aspect of the present invention relates to the fifteen aspect of the invention, and a summary thereof is that,

the importance transmitter includes either a macroblock importance of macroblocks contained in a forward packet which is transmitted before a packet containing the macroblock, or a macroblock importance of macroblocks contained in a backward packet which is transmitted after a packet containing the macroblock on the packet and the importance transmitter transmits the packet.

A seventeen aspect of the present invention relates to the fifteen aspect of the invention, and a summary thereof is that, the importance transmitter includes the macroblock importance in a packet different from a packet containing the macroblocks and then transmits the macroblock importance.

A eighteen aspect of the present invention relates to the fifteen aspect of the invention, and the moving picture data transmission apparatus further including a judgment unit configured to judge whether to add an error correction code to a packet based on values of the weights assigned to the macroblocks contained in the packet to be transmitted. Furthermore, if the judgment unit judges that the error correction code is not added to the packet, the transmission method controller transmits the packet without adding the error correction code to the packet.

An nineteen aspect of the present invention is defined as a moving picture data transmission apparatus including: a packet reception unit configured to sequentially receive packets each containing macroblocks, in which a picture frame is divided; an importance reception unit configured to receive a macroblock importance indicating weights assigned to the macroblocks; an importance determiner configured to determine a specific macroblock importance of macroblocks contained in a specific packet which the packet reception unit has lost due to failure to receive; and a retransmission request unit configured to request retransmission of the specific packet if the specific macroblock importance determined by the importance determiner exceeds a predetermined threshold value.

A twentieth aspect of the present invention relates to the nineteenth aspect of the invention, and a summary thereof that the specific macroblock importance is contained in either a forward packet received before the specific packet and a backward packet received after the specific packet, and the importance determiner determines the specific macroblock importance by using the specific macroblock importance contained in either the forward packet or the backward packet.

An twenty-first aspect of the present invention is defined as a moving picture data transmission apparatus including: a packet reception unit configured to sequentially receive packets each containing macroblocks, in which a picture frame is divided; a decoding processor configured to execute is a decoding process of the macroblocks received by the packet reception unit; and an importance reception unit configured to receive a macroblock importance indicating weights assigned to the macroblocks. Further more if the macroblock importance received by the importance reception unit is equal or less than a predetermined threshold value, the decoding processor omits at least a part of the decoding process.

In summary, according to the aspects of the present invention, it becomes possible to provide a moving picture data transmission apparatus whereby macroblocks containing the important parts can be transmitted with higher reliability.

### BRIEF DESCRIPTION OF THE DRAWINGS

FIG. 1 is a logical block configuration diagram of a moving picture data transmission apparatus according to a first embodiment of the present invention.

FIG. 2 is an operational flowchart of the moving picture data transmission apparatus according to the first embodiment of the present invention.

FIG. 3 is an illustration showing a configuration example of a picture frame according to the embodiment of the present invention.

FIG. 4 is an illustration showing an example of a reference picture block according to the embodiment of the present invention.

FIG. 5 is an illustration showing an example of the reference picture block and a macroblock according to the embodiment of the present invention.

FIG. 6 is an illustration showing another example of the reference picture block and the macroblock according to the embodiment of the present invention.

FIGS. 7A and 7B are illustrations showing configuration examples of packets according to the embodiment of the present invention.

FIGS. 8A and 8B are illustrations showing other configuration examples of the packet according to the embodiment of the present invention.

FIGS. 9A and 9B are illustrations showing a configuration example of a picture frame according to a modified example of the first embodiment of the present invention.

FIG. 10 is an illustration showing a configuration example of a reference picture block according to the modified example of the first embodiment of the present invention.

FIG. 11 is a logical block configuration diagram of a moving picture data transmission apparatus according to a second embodiment of the present invention.

FIGS. 12A to 12C are an operational flowchart of the moving picture data transmission apparatus according to the second embodiment of the present invention.

FIG. 13 is an operational flowchart of the moving picture data transmission apparatus according to the second embodiment of the present invention.

FIG. 14 is an operational flowchart of the moving picture data transmission apparatus according to the second embodiment of the present invention.

FIG. 15 is an operational flowchart of the moving picture data transmission apparatus according to the second embodiment of the present invention.

FIG. 16 is an operational flowchart of the moving picture data transmission apparatus according to the second embodiment of the present invention.

FIG. 17 is an illustration showing a configuration example of packet according to the second embodiment of the present invention.

FIG. 18 is an illustration showing a configuration example of packet according to the second embodiment of the present invention.

FIGS. 19A to 19C are illustrations showing configuration examples of packets according to the second embodiment of the present invention.

FIG. 20 is an illustration showing detailed configuration example of packets according to the second embodiment of the present invention.

### DESCRIPTION OF THE PREFERRED EMBODIMENTS

### First Embodiment

Hereinafter, a first embodiment of the present invention will be described. Note that, in the following descriptions on the drawings, corresponding or like reference numerals are given to corresponding or like elements. Here, it should be noted that the drawings are schematic and that ratios of one is measurement to another and the like are not drawn to scale.

Accordingly, specific measurements and the like should be figured out in consideration of the following descriptions. In addition, as a matter of course, across the drawings also, there are parts between which a relationship or a ratio in measurement is not equal to an actual one there between.

(Logical Block Configuration of Moving Picture Data Transmission Apparatus)

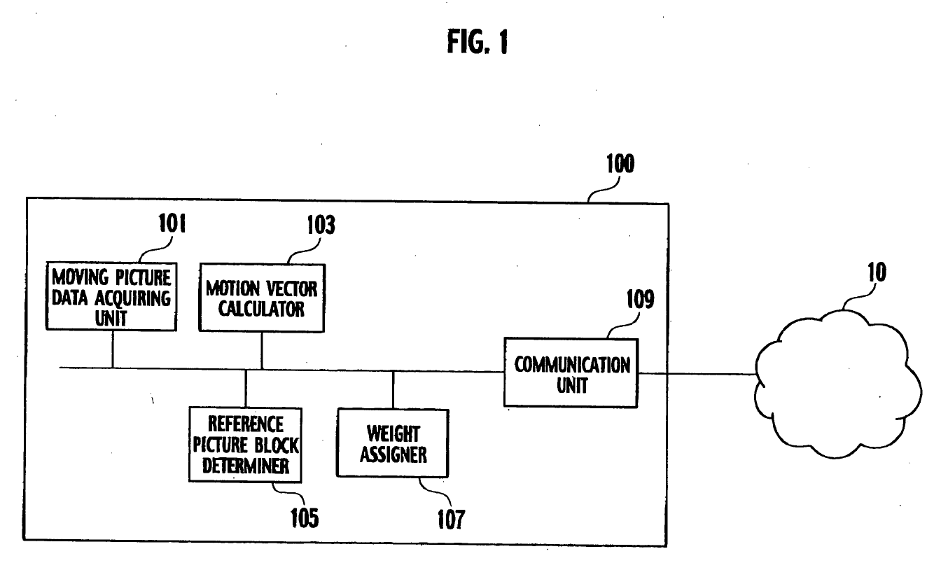

FIG. 1 shows a logical block configuration diagram of a moving picture data transmission apparatus 100 according to this embodiment. Note that, hereinafter, elements relating to the present invention will be mainly described. Accordingly, it should be noted that the moving picture data transmission apparatus 100 may include a logical block (a power supply or the like) being essential for realizing functions of the moving picture data transmission apparatus 100, for which an illustration or a description is omitted.

As shown in FIG. 1, the moving picture data transmission apparatus 100 is connected to a communication network 10 by wire or by radio.

The communication network 10 is a communication network for the purpose of transmitting an IP packet containing moving picture data transmitted by the moving picture data transmission apparatus 100.

The moving picture data transmission apparatus 100 includes a moving picture data acquiring unit 101, a motion vector calculator 103, a reference picture block determiner 105, a weight assigner 107, and a communication unit 109.

The moving picture data acquiring unit 101 is configured to acquire moving picture data. Specifically, the moving picture data acquiring unit 101 can acquire moving picture data from a server (not illustrated) which the moving picture data acquiring unit 101 can access through the communication network 10.

Additionally, the moving picture data acquiring unit 101 may be configured as a unit provided with an access interface for a recording medium (for example, a DVD or a tape) so as to be able to acquire moving picture data recorded in the recording medium.

The motion vector calculator 103 is configured to calculate a motion vector of each of macroblocks (16 pixels by 16 lines) contained in a picture frame.

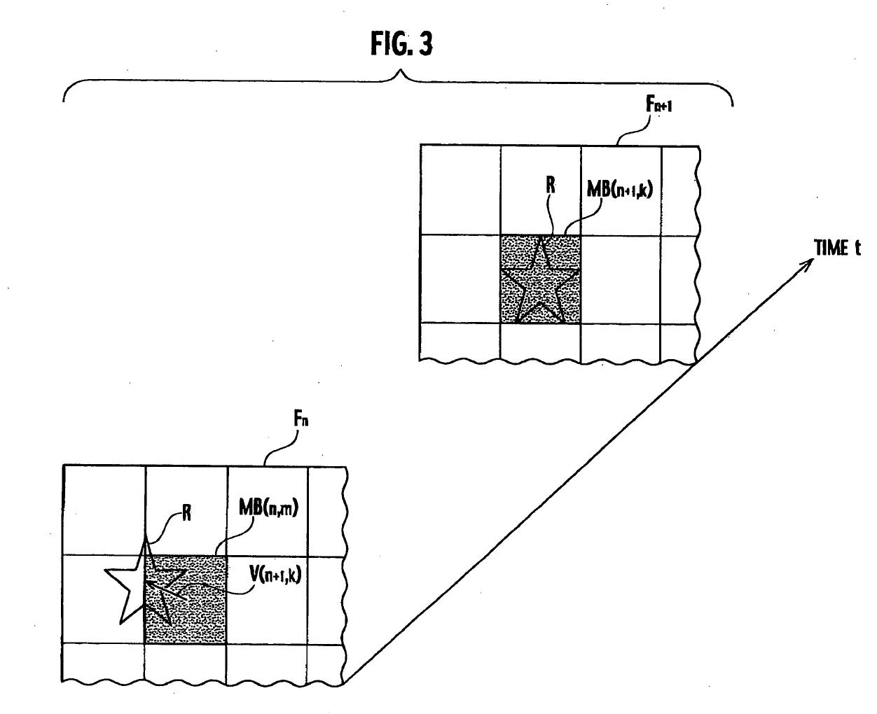

Specifically, as shown in FIG. 3, the motion vector calculator 103 calculates a motion vector V(n+1, k) of the macroblock MB (n+1, k), that is, a moving direction and a moving amount of the macroblock MB(n+1, k) on a picture frame based on a position of a reference picture element R on a picture frame Fₙ (a first picture frame) and also based on a position of a macroblock MB(n+1, k) (a backward macroblock) containing the reference picture element R on a picture frame Fₙ₊₁ (a second picture frame) reproduced after the picture frame Fₙ.

Note that the macroblock MB(n+1, k) may be configured to contain a part of the reference picture element R, not the entire reference picture element R.

More specifically, the motion vector calculator 103 calculates the motion vector V(n+1, k) by using luminance signals and color difference signals forming the macroblock MB(n+1, k). Note that the motion vector calculator 103 may calculate the motion vector V(n+1, k) by using either luminance signals or color difference signals.

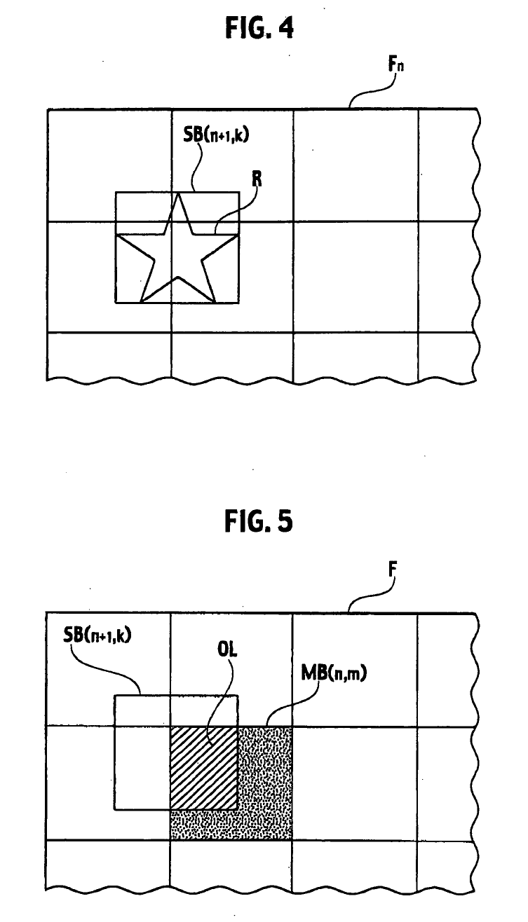

The reference picture block determiner 105 is configured to determine a reference picture block SB(n+1, k) (refer to FIG. 4) which is a region on the picture frame Fₙ containing the reference picture element R based on the motion vector V(n+1, k) calculated by the motion vector calculator 103.

Specifically, the reference picture block determiner 105 determines the reference picture block SB(n+1, k), which has the same size (16 pixels by 16 lines) as the macroblocks, based on the motion vector V(n+1, k).

The weight assigner 107 is configured to assign a weight to a macroblock MB(n, m) on a picture frame Fₙ, in accordance with the ratio of an overlap region where the reference picture block SB(n+1, k) overlaps the macroblock MB(n, m) on the picture frame F.

Specifically, as shown in FIG. 5, the weight assigner 107 assigns as the weight the ratio of the overlap region OL, where the reference picture block SB (n+1, k) overlaps the macroblock MB (n, m) on the picture frame F, to a region occupied by the macroblock MB (n, m).

More specifically, the weight assigner 107 calculates the weight (Wₛ) by using the formula (1).
Wₛ(n,m)=(SB(n+1,k)∩MB(n,m))/MB(n,m) (FORMULA 1)

Here, “SB(n+1, k)∩MB(n, m)” means an area size of the overlap region OL where the reference picture block SB(n+1, k) overlaps the macroblock MB(n, m).

For example, in a case where the reference picture block SB(n+1, k) overlaps the macroblock MB(n, k), if it is assumed that the motion vector V(n+1, k) (a, b), the weight (We) assigned to the macroblock MB(n, k) is calculated as follows.
Wₛ=(16−|a|)*(16−|b|)/(16*16)

Furthermore, the weight assigner 107 can determine a weight assigned to the macroblock MB (n, m) by using plural ones of the reference picture blocks determined by the reference picture block determiner 105.

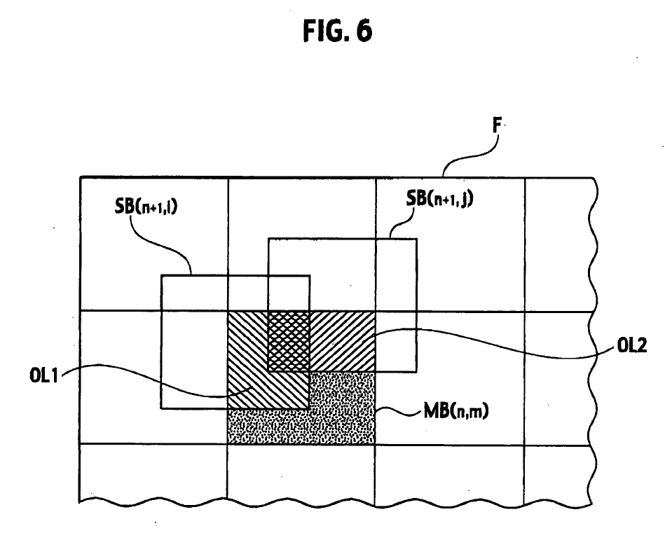

For example, as shown in FIG. 6, in a case where there are a reference picture block SB(n+1, i) and another reference picture block SB(n+1, J), the weight assigner 107 calculates a weight (Wₘ) based on the plurality ones of the reference picture blocks, on the basis of overlap regions OL1 and OL2 where the respective reference picture blocks overlaps the macroblock MB(n, m).

Specifically, the weight assigner 107 calculates the weight (Wₘ) based on the plurality of reference picture blocks by using the formula (2).
Wₘ(n,m)=(SB(n+1, i)∩MB(n,m)+SB(n+1, j)∩MB(n,m))/MB(n,m) (FORMULA 2)

The communication unit 109 shown in FIG. 1 is configured to provide a communication interface for the moving picture data transmission apparatus 100 to be connected to the communication network 10. The communication unit 109 can be provided with a suitable communication interface as appropriate in accordance with a configuration of the communication network 10. For example, the communication unit 109 can be provided with a LAN interface such as 100BASE-TX.

Additionally, the communication unit 109 is configured to control a transmission method of a macroblock, based on a weight assigned thereto (for example, the weight (Wₛ)) by the weight assigner 107. In this embodiment, the communication unit 109 constitutes a transmission method controller.

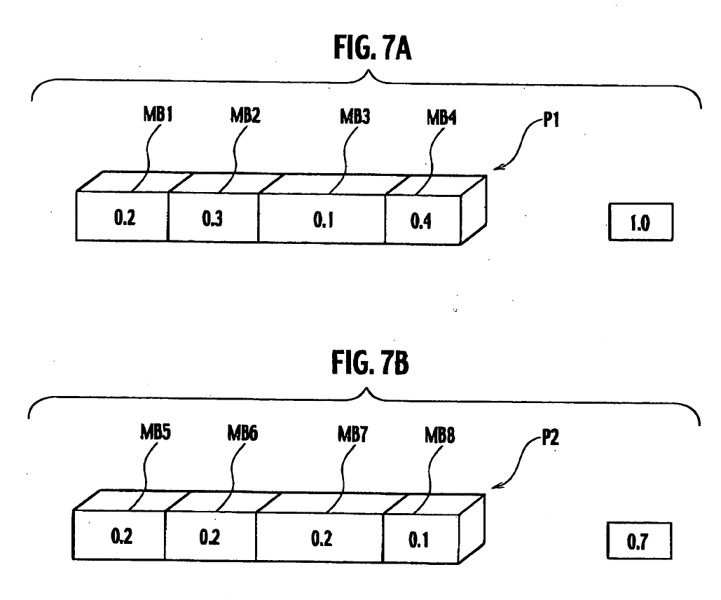

Specifically, as shown in FIGS. 7A and 7B, if a value of the weight exceeds a predetermined threshold value (for example, 1.0), the communication unit 109 transmits the macroblock more than once toward a transmission destination to which the moving picture data transmission apparatus 100 can be connected through the network 10.

More specifically, if a sum of weights assigned to a plurality of macroblocks contained in an IP packet (a packet) to be transmitted exceeds a predetermined threshold value (for example, 1.0), the communication unit 109 transmits the IP packet toward a transmission destination more than once.

Furthermore, if the weight is lower than a predetermined threshold value (for example, 0.5), the communication unit 109 does not transmit but discards the macroblock.

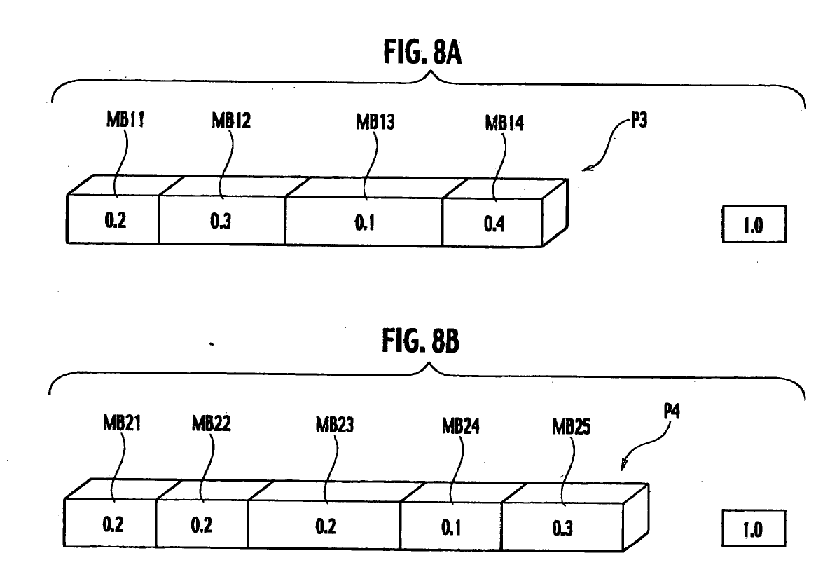

More specifically, as shown in FIGS. 8A and 8B, the communication unit 109 can also generate the IP packet so as to limit a sum of weights assigned to a plurality of macroblocks contained in an IP packet to be transmitted within a predetermined range (for example, from 0.8 to 1.2). Note that further specific operations of the communication unit 109 will be described later.

(Operation of Moving Picture Data Transmission Apparatus)

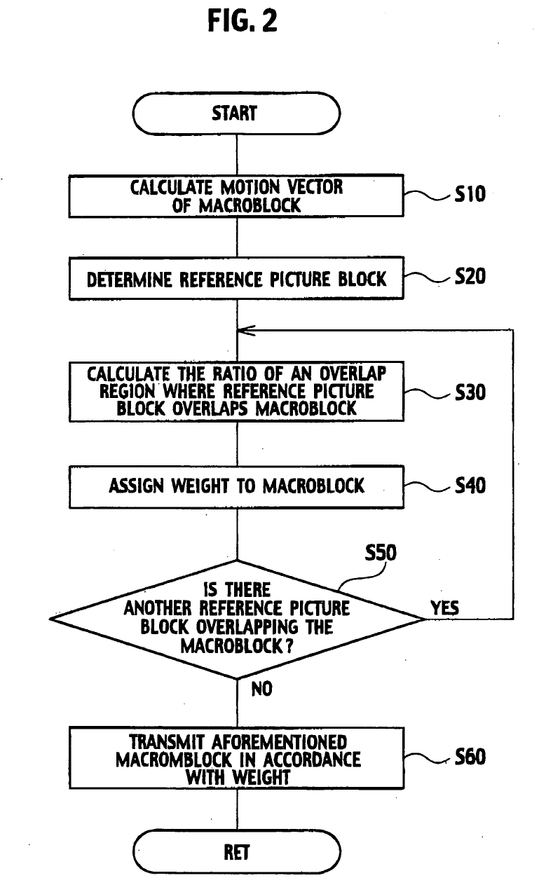

Next, operation of the abovementioned moving picture data transmission apparatus 100 according to this embodiment will be described. FIG. 2 is an operational flowchart of the moving picture data transmission apparatus 100.

As shown in the drawing, in Step S10, the moving picture data transmission apparatus 100 calculates a motion vector of a macroblock (16 pixels by 16 lines) contained in a picture frame F.

Specifically, as described above, the moving picture data transmission apparatus 100 calculates a motion vector V(n+1, k) of the macroblock MB(n+1, k), based on a position of the reference picture element R on the picture frame Fₙ and also based on a position of the macroblock MB (n+1, k) containing the reference picture element R on the picture frame Fₙ₊₁ reproduced after the picture frame Fₙ (refer to FIG. 3).

In Step S20, based on the calculated motion vector V(n+1, k), the moving picture data transmission apparatus 100 determines a reference picture block SB(n+1, k) which is a region on the picture frame Fₙ containing the reference picture element R (refer to FIG. 4). Note that, in Step S20, the moving picture data transmission apparatus 100 can also determine a plurality of reference picture blocks.

In Step S30, the moving picture data transmission apparatus 100 calculates a weight of a macroblock MB n, m) in accordance with the ratio of an overlap region where the macroblock MB (n, m) and the reference picture block SB(n+1, k) overlap each other on the picture frame F (refer to FIGS. 5 and 6).

Specifically, as described above, the moving picture data transmission apparatus 100 calculates a weight (Wₛ) (or a weight (Wₘ)) by using formula (1) (or formula (2)).

In Step S40, the moving picture data transmission apparatus 100 assigns the calculated weight (Wₛ) (or the weight (Wₘ)) to the macroblock MB (n, m).

For example, as shown in FIG. 7A, the moving picture data transmission apparatus 100 assigns the thus calculated weights (“0.2”, “0.3” and the like in the drawings) to the respective macroblocks MB1 to MB4.

Note that information indicating the weights may be expressed by using appropriate bits in the data field constituting the macroblocks MB(n, m).

Next, as shown in FIG. 2, in Step S50, the moving picture data transmission apparatus 100 judges whether or not there is another reference picture block overlapping the macroblock MB (n, m) on the picture frame F beside the reference picture block SB(n+1, k) which is targeted in processes in Steps S30 and S40.

If there is such another reference picture block overlapping the macroblock MB(n, m) (“Yes” in Step S50), the moving picture data transmission apparatus 100 repeats the processes in Step S30 and thereafter.

If there is not such another reference picture block overlapping the macroblock MB (n, m) (“No” in Step S50), in Step S60, the moving picture data transmission apparatus 100 transmits the macroblock MB(n, m) in accordance with the assigned weight. The moving picture data transmission apparatus 100 determines how the macroblock MB (n, m) should be transmitted in accordance with set conditions.

For example, as shown in FIGS. 7A and 7B, a sum of weights assigned to the macroblocks MB1 to MB4 contained in an IP packet P1 is “1.0.” On the other hand, a sum of weights assigned to the macroblocks MB5 to MB8 contained in an IP packet P2 is “0.7.”

In this case, the moving picture data transmission apparatus 100 transmits only the IP packet P1, and does not transmit but discards the IP packet P2.

Additionally, as shown in FIGS. 5A and 5B, the moving picture data transmission apparatus 100 can generate the IP is packet so as to limit a sum of weights assigned to a plurality of macroblocks contained in an IP packet to be transmitted within a predetermined range (for example, from 0.8 to 1.2).

An IP packet P3 contains “four” macroblocks MB11 to MB14 and a sum of weights assigned to these macroblocks is “1.0.”

On the other hand, an IP packet P4 contains “five” macroblocks MB21 to MB25 and a sum of weights assigned to these macroblocks is “1.0” as in the case with the IP packet P3. That is, in order to limit a sum of weights assigned to a plurality of macroblocks contained in an IF packet to be transmitted within a predetermined range, the moving picture data transmission apparatus 100 regulates a number of macroblocks, i.e, a packet length in the IP packet.

(Effects and Advantages)

By the above described moving picture data transmission apparatus 100 according to this embodiment, the weight (Wₛ) is assigned to the macroblock MB (n, m) in accordance with the ratio of an overlap region OL where the reference picture block SB (n+1, k) overlaps the macroblock MB(n, m) on the picture frame F.

Furthermore, the communication unit 109 controls a transmission method of the macroblock MB(n, m) based on the assigned weight (Wₛ). Specifically, the communication unit 109 transmits the macroblock MB(n, m) more than once if the weight (Wₛ) exceeds a predetermined threshold value. Thereby, macroblocks containing important parts can be transmitted with higher reliability.

By the moving picture data transmission apparatus 100, the weight (Wₛ) assigned to the macroblock MB (n, m) is determined by using a plurality of reference picture blocks (the reference picture blocks SB(n+1, i) and SB(n+1, j)). Thereby, macroblocks containing important parts desirable to be reliably transmitted to a transmittance destination, i.e., macroblocks containing motion on the image frame F, can be more accurately determined.

By the moving picture data transmission apparatus 100, the IP packets are generated so as to limit a sum of weights assigned to a plurality of macroblocks contained in IP packets (the IP packets P3 and P4) to be transmitted can be within a predetermined range.

Accordingly, even when an IP packet transmitted by the moving picture data transmission apparatus 100 is lost on the communication network 10 (in an event so called “a packet loss”), or contains an error, it is possible to stabilize impacts on the moving picture data reproduced at the transmission destination.

That is, even when the IP packet is lost before it arrives at the destination, it is possible to limit a degree of degradation of the moving picture data to a constant level.

By the moving picture data transmission apparatus 100, if a weight assigned to a macroblock is lower than a predetermined threshold value, the moving picture data transmission apparatus 100 can discard the macroblock without transmitting it.

Hence, in such a case where a communication band (throughputs) of the communication network 10 are restricted, by deleting macroblocks having relatively low weights, it becomes possible to realize moving picture data transmission while large degradation of picture quality is avoided and which matches a communication band of the communication network 10.

(Variants)

Although an example of controlling a transmission method of a macroblock based on a weight assigned to a macroblock has been described in the abovementioned embodiment of the present invention, the transmission method is not limited to the abovementioned embodiment.

For example, based on a weight assigned to a macroblock, a QoS control, such as a priority control, may be executed with respect to transmission of an IP packet.

Additionally, while the ratio of the overlap region OL to the region occupied by the macroblock MB(n, m), which is obtained by using formula (1), is used as the weight, a different formula than formula (1) may be used as long as the formula can obtain the ratio of the overlap region OL to the region occupied by the macroblock MB(n, m).

Furthermore, a calculation method of a weight assigned to a macroblock can be modified as follows.

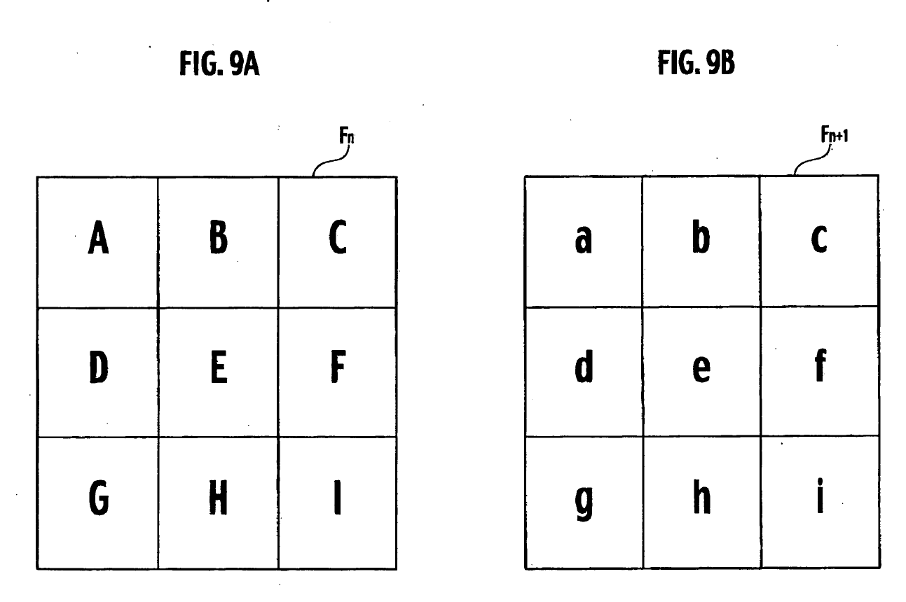

FIGS. 9A, and 9B show macroblocks contained in the picture frame Fₙ, and in the picture frame Fₙ₊₁ reproduced after the picture frame Fₙ, respectively. Here, the macroblocks contained in the picture frame Fₙ are denoted by reference characters A to I, and the macroblocks contained in the picture frame Fₙ₊₁ are denoted by reference characters a to i.

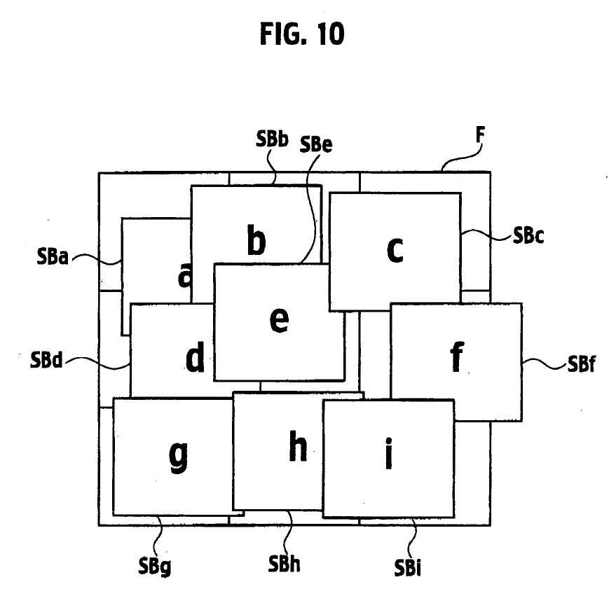

FIG. 10 shows reference picture blocks SBa to SBi determined based on motion vectors of the macroblocks a to i shown in FIG. 9B.

The moving picture data transmission apparatus 100 calculates weights assigned to the respective macroblocks A to I, based on ratios of overlap regions where the respective reference picture blocks SBa to SBi shown in FIG. 10 overlap the respective macroblocks A to I on the picture frame Fₙ shown in FIG. 9A.

For example, by using the formula (3), the moving picture data transmission apparatus 100 calculates a weight W_{E} of a macroblock E(MB(E)) located practically at the center of the picture frame Fₙ.

$${W}_{E} MB ( E ) ⋂ SB ( a ) \times {w}_{a} + MB ( E ) ⋂ SB ( b ) \times {w}_{b} + MB ( E ) ⋂ SB ( c ) \times {w}_{c} + MB ( E ) ⋂ SB ( d ) \times {w}_{d} + MB ( E ) ⋂ SB ( e ) \times {w}_{e} + MB ( E ) ⋂ SB ( f ) \times {w}_{f} + MB ( E ) ⋂ SB ( g ) \times {w}_{g} + MB ( E ) ⋂ SB ( h ) \times {w}_{h} + MB ( E ) ⋂ SB ( i ) \times {w}_{i} \qquad ( Formula 3 )$$

Here, for example, “MB(E)∩SB(a)” means an area size of the overlap region where the reference picture block SBa overlaps the macroblock (A). Additionally, wₐ to wᵢ can be set to any values depends on a content of moving picture data processed by the moving picture data transmission apparatus 100.

In line with a calculation of a weight of a macroblock by using the formula 3, for example, by enlarging values for wₐ, w_{b}, w_{c}, w_{g}, wₕ and wᵢ used for the respective macroblocks A, B, C, G, H and I located at levels upper and lower than the macroblock E, these macroblocks can be transmitted with priorities higher than the other macroblocks.

Furthermore, by calculating weights with respect to picture frames (for example, up to 2 or 3 picture frames) reproduced after the picture frame Fₙ₊₁, the weights may be reflected in wₐ to wᵢ.

By applying a method as described above, it becomes possible to perform weight assignment to macroblocks which reflects states of a few picture frames following a current picture frame.

### Second Embodiment

Hereinafter, a second embodiment of the present invention will be described. In this embodiment, macroblocks containing “important parts” are transmitted more reliably by more efficiently utilizing weights assigned to macroblocks.

(Logical Block Configuration of Moving Picture Data Transmission Apparatus)

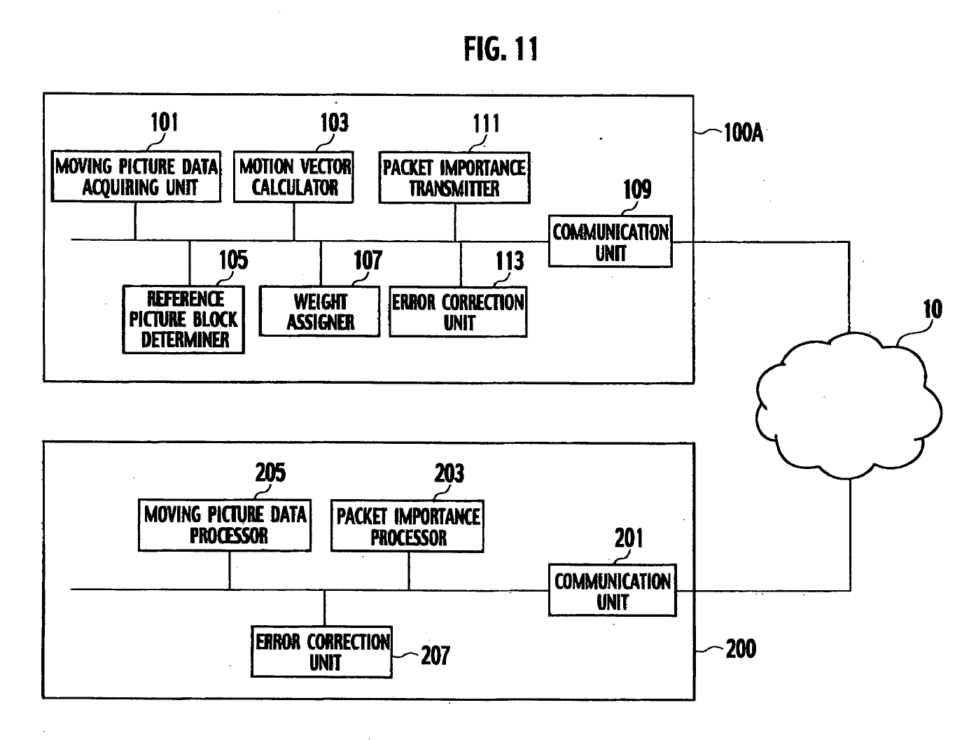

FIG. 11 shows logical block configurations of a moving picture data transmission apparatus 100A and a moving picture data transmission apparatus 200 according to this embodiment. Note that, hereinafter, elements different from the first embodiment will be mainly described, and descriptions on elements corresponding to those in the first embodiment will be omitted.

(1) Moving Picture Data Transmission Apparatus 100A

In comparison with the moving picture data transmission apparatus 100 (refer to FIG. 1), a packet importance transmitter 111 and an error correction unit 113 are added to the moving picture data transmission apparatus 100A.

The packet importance transmitter 111 is configured to transmit macroblock importance indicating weights assigned to macroblocks to a destination, more precisely, the moving picture data transmission apparatus 200.

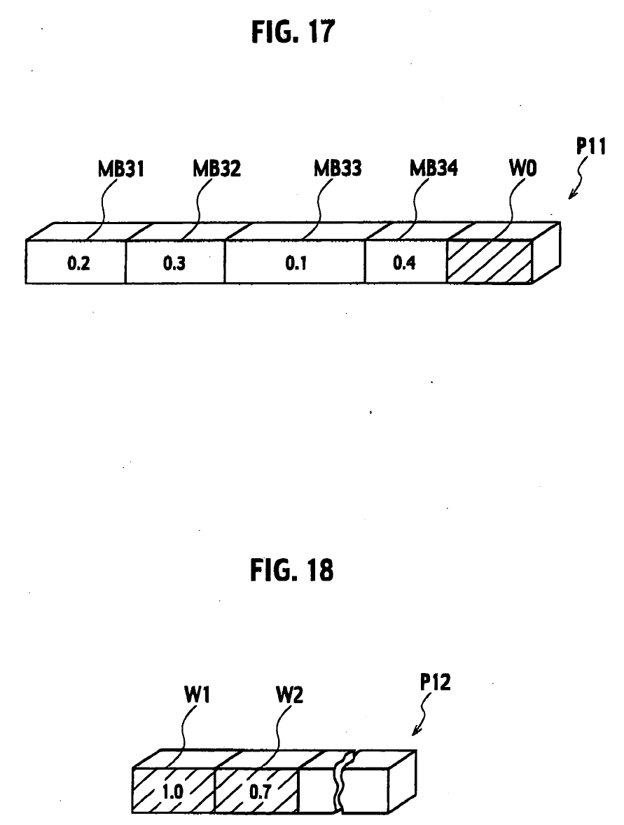

FIG. 17 shows an example of an IP packet transmitted from the moving picture data transmission apparatus 100A to the moving picture data transmission apparatus 200. As shown in FIG. 17, the IP packet P11 contains macroblocks MB31 to MB34.

The packet importance transmitter 111 includes weights for the macroblocks MB31 to MB34 (0.2/0.3/0.1/0.4) in a macroblock importance W0. Additionally, the packet importance transmitter 111 transmits the macroblock importance W0 by adding the macroblock importance W0 to the IP packet P11.

Moreover, the packet importance transmitter 111 can transmit a macroblock importance (of macroblocks) by including the macroblock importance in an IP packet different from an IP packet containing the macroblocks.

FIG. 18 shows another example of an IP packet transmitted from the moving picture data transmission apparatus 100A to the moving picture data transmission apparatus 200. As shown in FIG. 18, an IP packet P12 contains a macroblock importance W1 which is a sum of the weights assigned to the macroblocks MB1 to MB4 contained in the IP packet P1 (refer to FIG. 7A), and also contains a macroblock importance W2 which is a sum of the weights assigned to the macroblocks MB5 to MB8 contained in the IP packet P2 (refer to FIG. 7B).

The packet importance transmitter 111 can transmit the macroblock importance W1 and W2 by including them in the IP packet P12 different from the IP packets P1 and P2 which contain the macroblocks (MB1 to MBB).

The packet importance transmitter 111 can transmit macroblock importance to the moving picture data transmission apparatus 200 in a configuration different from the configurations shown in FIGS. 17 and 18.

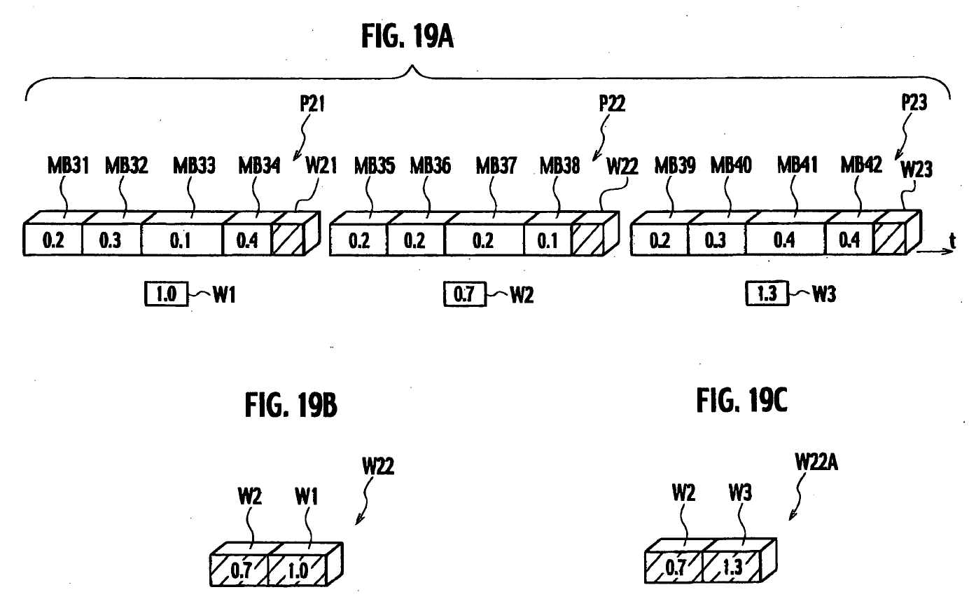

FIGS. 19A to 19C show another example of an IP packet transmitted from the moving picture data transmission apparatus 100A to the moving picture data transmission apparatus 200.

As shown in FIG. 19A, IP packets P21, P22 and P23 are sequentially transmitted from the moving picture data transmission apparatus 100A to the moving picture data transmission apparatus 200.

The IP packet P21 contains macroblocks MB31 to MB34. Similarly, the IP packet P22 contains macroblocks MB35 to MB38, and the IP packet 23 contains macroblocks MB39 to MB42. Additionally, macroblock importance W21 to W23 is added respectively to the IP packets P21 to P23.

FIG. 19B shows contents of the macroblock importance W22 added to the IP packet P22. The macroblock importance W22 contains macroblock importance W2 and W1 which are, respectively, a sum of weights assigned to the macroblocks MB35 to MB38 (0.7) contained in the IP packet P22, and a sum of weights assigned to the macroblocks MB31 to MB34 (1.0) contained in the IP packet P21 transmitted before the IP packet 22.

That is, the packet importance transmitter 111 can transmit the macroblock importance W1 of the macroblocks MB31 to MB34 contained in the IP packet P21 (a forward packet) which is transmitted before the IP packet 22 by including the macroblock importance W1 in the IP packet P22.

Moreover, the packet importance transmitter 111 can transmit a macroblock importance W22A as shown in FIG. 19C, in place of the macroblock importance W22. The macroblock importance W22A contains the macroblock importance W2 and a macroblock importance W3, which is a sum of weights assigned to the macroblocks MB39 to MB42 (1.3) contained in the IP packet P23 transmitted after the IP packet P22.

That is, the packet importance transmitter 111 can transmit the macroblock importance W3 of the macroblocks MB39 to MB42 which are contained in the IP packet P23 (a backward packet) transmitted after the IP packet 22 by including the macroblock importance W3 in the IP packet P22.

The error correction unit 113 is configured to add an error correction code, which is more specifically an FEC (forward error correction) code, to an IP packet transmitted to the moving picture data transmission apparatus 200.

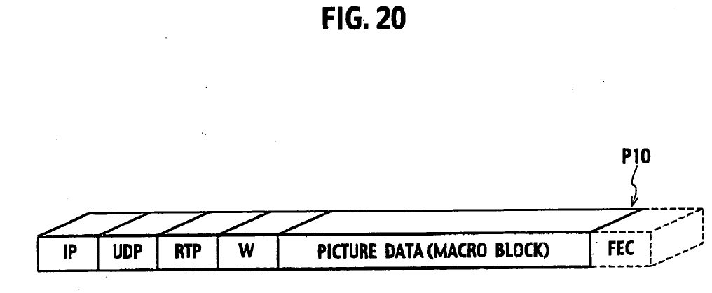

FIG. 20 shows a detailed configuration example of an IP packet transmitted by the moving picture data transmission apparatus 100A. As shown in FIG. 20, the IP packet P10 is constituted of an IP header, a UDP header, and an RTP header, and a weight W (a macroblock importance), picture data (macroblocks) and the FEC code.

Particularly, in this embodiment, based on a value of the weight (W) assigned to the macroblocks contained in the IP packet P10 to be transmitted, the error correction unit 113 can judge whether to add the FEC code to the IP packet P10. In this embodiment, the error correction unit 113 constitutes a judgment unit.

Additionally, if the error correction unit 113 judges that the FEC code is not added to the IP packet P10, a communication unit 109 according to this embodiment transmits the IP packet P10 to which the FEC code is not added.

Note that a method of adding the weight W (the macroblock importance) is not limited to the configuration where the weight W is added as a header of the IP packet P10. The weight W may be added to a header portion of the picture data.

(2) Moving Picture Data Transmission Apparatus 200

As shown in FIG. 11, the moving picture data transmission apparatus 200 receives IP packets transmitted by the moving picture data transmission apparatus 100A through the communication network 10. Additionally, the moving picture data transmission apparatus 200 executes a decoding process of macroblocks contained in the received IP packets and then replays moving picture data.

The moving picture data transmission apparatus 200 includes a communication unit 201, a packet importance processor 203, a moving picture data processor 205, and an error correction unit 207.

The communication unit 201 is configured to provide a communication interface for the moving picture data transmission apparatus 200 to be connected to the communication network 10. The communication unit 201 can be provided with a suitable communication interface as appropriate in accordance with a configuration of the communication network 10.

Particularly, in this embodiment, the communication unit 201 sequentially receives IP packets each containing macroblocks, in which a picture frame is divided (for example, the picture frame Fₙ shown in FIG. 3). In this embodiment, the communication unit 201 constitutes a packet reception unit.

Additionally, when a macroblock importance determined by the packet importance processor 203 exceeds a predetermined threshold value, the communication unit 201 requests retransmission of an IP packet (a specific IP packet) containing the macroblocks to which the macroblock importance is assigned. In this embodiment, the communication unit 201 constitutes a retransmission request unit.

The packet importance processor 203 is configured to execute processes related to a macroblock importance indicating weights assigned to macroblocks.

The packet importance processor 203 receives a macroblock importance contained in an IP packet (for example, the IP packet P11 shown in FIG. 17) transmitted by the moving picture data transmission apparatus 100A. In this embodiment, the packet importance processor 203 constitutes an importance reception unit.

Additionally, based on a plurality of received macroblock importance of macroblocks, the packet importance processor 203 determines a macroblock importance (a specific macroblock importance) of macroblocks contained in a lost IP packet (a specific packet) which the communication unit 201 has failed to receive. In this embodiment, the packet importance processor 203 constitutes an importance determiner.

Specifically, the packet importance processor 203 calculates a sum value (a received sum value) of weights (a macroblock importance) of macroblocks constituting one picture frame (for example, the picture frame Fₙ) based on IP packets received by the communication unit 201. Here, a sum value (standard sum value) of weights of macroblocks per each picture frame is substantially constant.

Consequently, by subtracting the received sum value from the standard sum value, the packet importance processor 203 determines weights (a macroblock importance) of the macroblocks contained in the lost IP packet.

Additionally, the packet importance processor 203 can receive an IP packet (the IP packet 12 shown in FIG. 18) containing only a macroblock importance.

Furthermore, when the lost IP packet is the IP packet P21 (the specific packet) as shown in FIGS. 19A and 19B, the packet importance processor 203 can determine the macroblock importance W1 of macroblocks contained in the lost IP packet 21, by using the macroblock importance W1 (the specific macroblock importance) contained in the IP packet 22 (the backward packet) received after the IP packet 21.

Alternatively, when the lost IP packet is the IP packet P23 (the specific packet) as shown in FIGS. 19A and 19C, the packet importance processor 203 can determine the macroblock importance W3 of macroblocks contained in the lost IP packet 23, by using the macroblock importance W3 (the specific macroblock importance) contained in the IP packet 22 (the earlier packet) received before the IP packet 23.

The moving picture data processor 205 is configured to execute a decoding process of macroblocks contained in IP packets received by the communication unit 201. In this embodiment, the moving picture data processor 205 constitutes a decoding processor.

Particularly, in this embodiment, the moving picture data processor 205 can modify contents of the decoding process based on a macroblock importance received by the packet importance processor 203.

For example, when a macroblock importance is not more than a predetermined threshold value, the moving picture data processor 205 can omit at least part of the decoding process. Specifically, among macroblocks (for example, the macroblocks MB31 to MB34) corresponding to the concerned macroblock importance, the moving picture data processor 205 is capable of executing a decoding process only with respect to a macroblock having a weight not less than a predetermined threshold value (for example, 0.3), and is also capable of omitting entire decoding process of the macroblocks.

The error correction unit 207 is configured to execute an error correction process by using the FEC code (refer to FIG. 20) contained in an IP packet received by the communication unit 201. Note that, when the FEC code is not added to the IP packet, the error correction unit 207 does not execute the error correction process at all.

(Operations of Moving Picture Data Transmission Apparatus)

Next, operations of the above described moving picture data transmission apparatus 100A and moving picture data transmission apparatus 200 according to this embodiment will be described.

(1) Transmission of a Macroblock Importance

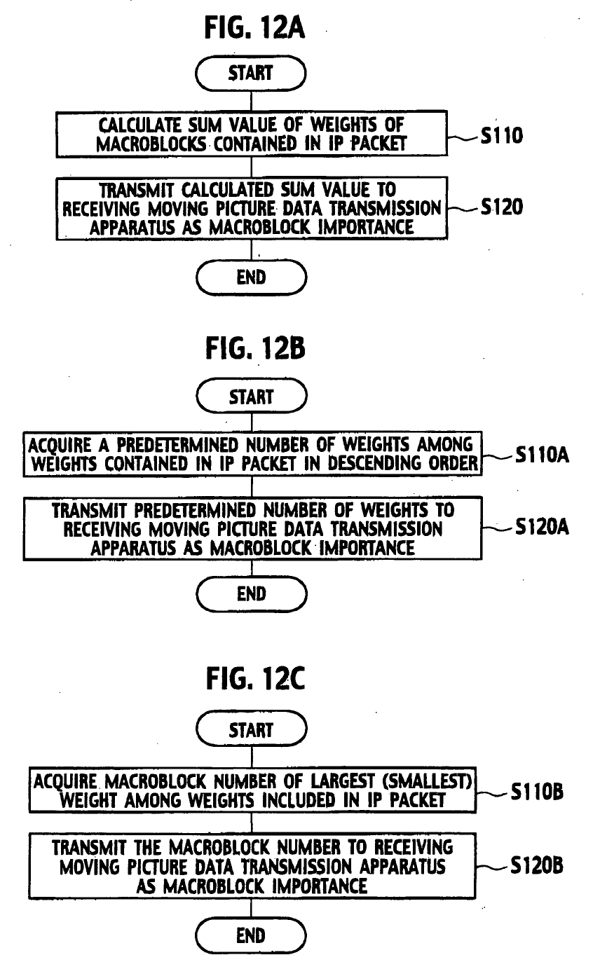

FIGS. 12A to 12C are operational flowcharts of the moving picture data transmission apparatus 100A for transmission of a macroblock importance.

(1.1) Transmission of a Sum Value of a Macroblock Importance

As shown in FIG. 12A, in Step S110, the moving picture data transmission apparatus 100A calculates a sum value of weights respectively assigned to macroblocks contained in an IP packet as the macroblock importance W1. For example, the moving picture data transmission apparatus 100A calculates the macroblock importance W1 and W2 shown in FIG. 18.

In Step S120, the moving picture data transmission apparatus 100A transmits the calculated sum values as the macroblock importance W1 and W2 to the moving picture data transmission apparatus 200 of a reception side.

Specifically, the moving picture data transmission apparatus 100A transmits the IP packet P12 containing the macroblock importance W1 and W2 to the moving picture data transmission apparatus 200.

(1.2) Transmission of Selected Macroblock Importance

The moving picture data transmission apparatus 100A can execute operations shown in FIG. 12B in place of the operations shown in FIG. 12A. As shown in FIG. 12B, in Step S110A, the moving picture data transmission apparatus 100A acquires a predetermined number of weights in descending order among weights respectively assigned to macroblocks contained in an IP packet.

For example, with respect to the IP packet P11 shown in FIG. 17, the moving picture data transmission apparatus 100A acquires the weights (0.4 and 0.3) assigned respectively to the macroblock MB34 having the largest weight, and to the macroblock MB32 having the next largest weight to the macroblock MB34.

In Step S120A, the moving picture data transmission apparatus 100A transmits the predetermined number of the weights (0.4 and 0.3) as the macroblock importance W0 (refer to FIG. 17) to the moving picture data transmission apparatus 200 of a reception side.

Specifically, the moving picture data transmission apparatus 100A transmits the IP packet P11 containing the macroblock importance W0 to the moving picture data transmission apparatus 200.

(1.3) Transmission of a Specific Macroblock Importance

Furthermore, the moving picture data transmission apparatus 100A can execute operations shown in FIG. 12C. As shown in FIG. 12C, in Step S110B, the moving picture data transmission apparatus 100A acquires a macroblock number whose weight is the largest (or smallest) among weights respectively assigned to macroblocks contained in an IP packet.

For example, with respect to the IP packet P11 shown in FIG. 17, the moving picture data transmission apparatus 100A acquires a number for the macroblock MB34 whose weight is the largest.

In Step S120B, the moving picture data transmission apparatus 100A transmits the number for the macroblock as the macroblock importance W0 (refer to FIG. 17) to the moving picture data transmission apparatus 200 of a reception side.

(2) Decoding Process Using Macroblock Importance

Next, operations related to a decoding process using macroblock importance will be described. Specifically, three operation examples carried out by the moving picture data transmission apparatus 200 of a reception side will be described.

(2.1) Operation Example 1

In this operation example, whether to request retransmission of a lost IP packet is judged by using macroblock importance.

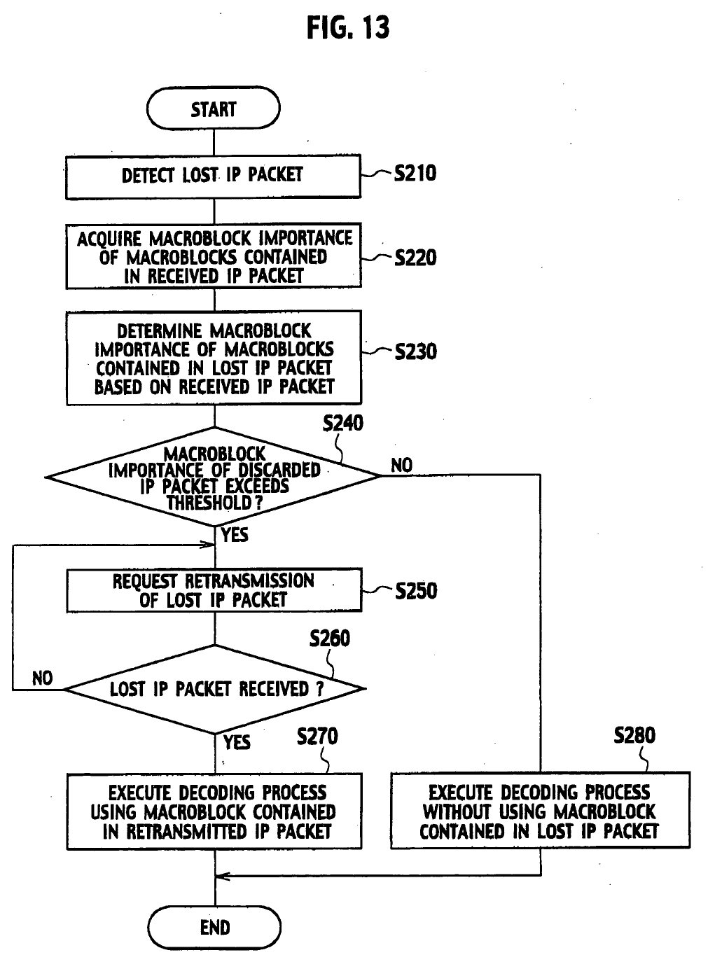

As shown in FIG. 13, in Step S210, the moving picture data transmission apparatus 200 detects an IP packet lost in the communication network 10 (for example, the IP packet P11) based on sequence numbers contained in IP packets received from the moving picture data transmission apparatus 100A.

In Step S220, the moving picture data transmission apparatus 200 acquires macroblock importance contained in the received IP packets.

In Step S230, based on the acquired macroblock importance, the moving picture data transmission apparatus 200 determines a macroblock importance of macroblocks contained in the lost IP packet (the IP packet P11).

Specifically, as described above, by subtracting the received sum value, which is a sum value of a macroblock importance of macroblocks contained in the received IP packet, from the standard sum value of a macroblock importance of macroblocks constituting each picture frame, the moving picture data transmission apparatus 200 determines weights (the macroblock importance) of macroblocks contained in the lost IP packet.

In Step S240, the moving picture data transmission apparatus 200 judges whether the macroblock importance of the lost IP packet (the macroblocks) exceeds a predetermined threshold value.

If the macroblock importance of the lost IP packet exceeds the threshold value (“Yes” in Step S240), the moving picture data transmission apparatus 200 requests retransmission of the lost IP packet in Step S250.

In Step S260, the moving picture data transmission apparatus 200 judges whether it has received the lost IP packet.

If the moving picture data transmission apparatus 200 has received the lost IP packet (“Yes” in Step S260), in Step S270, the moving picture data transmission apparatus 200 executes a decoding process by using macroblocks contained in the retransmitted IP packet.

If the moving picture data transmission apparatus 200 has not been able to receive the lost IP packet (“No” in Step S260), the moving picture data transmission apparatus 200 repeats processes from Step S250 to later.

If the macroblock importance of the lost IP packet is equal or less than the threshold value (“No” in Step S240), in Step S280, the moving picture data transmission apparatus 200 executes a decoding process without using the macroblocks contained in the lost IP packet.

Note that, in a case where the macroblock importance is transmitted by the IP packet 12 different from an IP packet containing macroblocks, the moving picture data transmission apparatus 200 may execute processes from Step S240 to later based on the macroblock importance contained in the IP packet 12.

(2.2) Operation Example 2

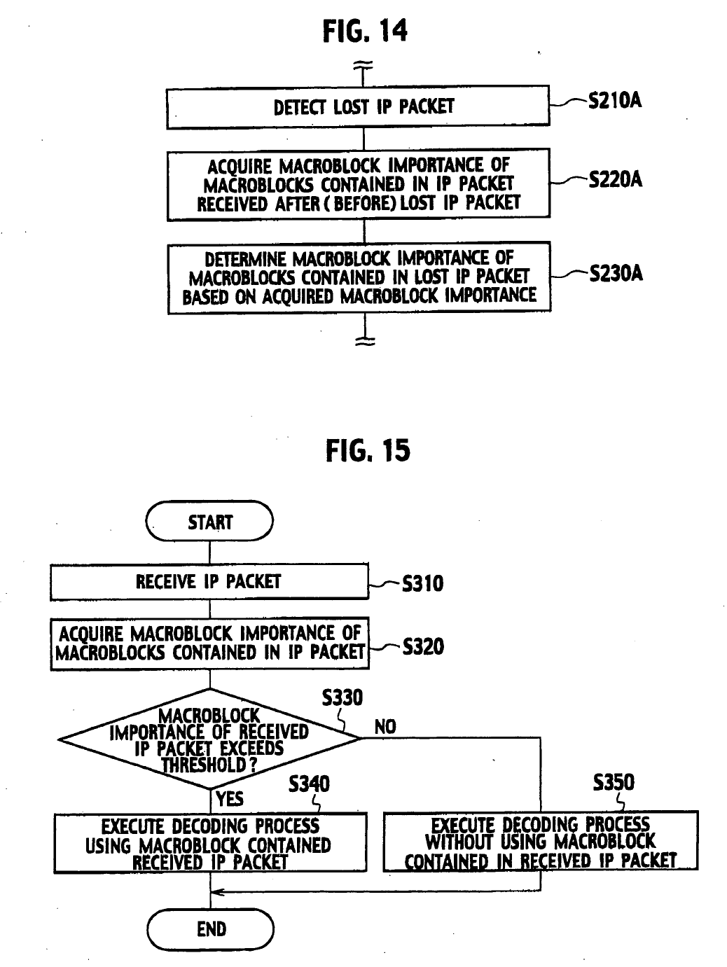

FIG. 14 is an operational flow chart executed in place of the processes of Steps S210 to S230 in the flow according to Operation Example 1 shown in FIG. 13.

Step S210A is the same as that in Step S210 shown in FIG. 13. In Step S220A, the moving picture data transmission apparatus 200 acquires a macroblock importance (the macroblock importance W22) contained in an IP packet (the IP packet P22) received after a lost IP packet (for example, the IP packet P21 shown in FIG. 19A).

In Step S230A, the moving picture data transmission apparatus 200 determines a macroblock importance (the macroblock importance W1) of macroblocks contained in the lost IP packet based on the acquired macroblock importance (the macroblock importance W22).

Specifically, as shown in FIG. 19B, based on the macroblock importance W1 contained in the macroblock importance W22, the moving picture data transmission apparatus 200 determines the macroblock importance of macroblocks contained in the lost IP packet.

Note that, as shown in FIGS. 19A and 19B, in a case where the lost IP packet is the IP packet P23, the moving picture data transmission apparatus 200 can determine a macroblock importance W3 based on the macroblock importance W22A contained in the IP packet P22 received before the IP packet P23.

(2.3) Operation Example 3

In this operation example, whether to execute a decoding process of the macroblocks is judged based on received macroblock importance.

As shown in FIG. 15, in Step S310, the moving picture data transmission apparatus 200 receives an IP packet from the moving picture data transmission apparatus 100A.

In Step S320, the moving picture data transmission apparatus 200 acquires a macroblock importance of macroblocks contained in the received IP packet.

In Step S330, the moving picture data transmission apparatus 200 judges whether the macroblock importance of the received IP packet (the macroblocks) exceeds a predetermined threshold value.

If the macroblock importance exceeds the predetermined threshold value (“Yes” in Step S330), in Step S340, the moving picture data transmission apparatus 200 executes a decoding process by using macroblocks contained in the received IP packet.

If the macroblock importance is equal or less than the threshold value (“No” in Step S330), in Step S350, the moving picture data transmission apparatus 200 executes a decoding process without using the macroblocks contained in the received IP packet.

(3) Omission of the Error Correction Code

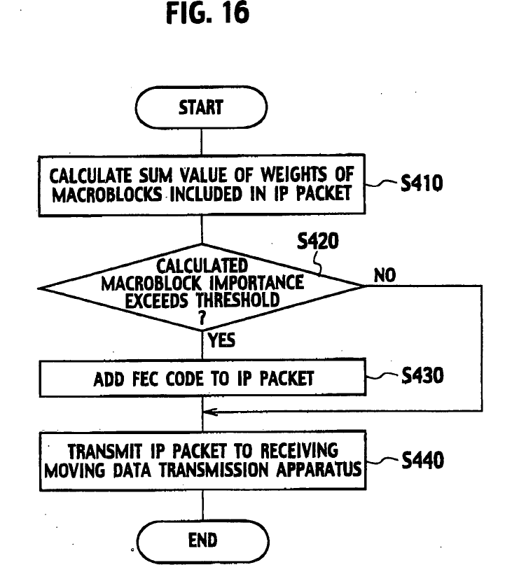

FIG. 16 is a flow chart of an operation of adding the error correction code (the FEC code) to the moving picture data transmission apparatus 100A.

As shown in FIG. 16, in Step S410, the moving picture data transmission apparatus 100A calculates a sum value of weights assigned to macroblocks contained in an IP packet as a macroblock importance.

In Step S420, the moving picture data transmission apparatus 100A judges whether the calculated macroblock importance exceeds a predetermined threshold value.

If the macroblock importance exceeds the predetermined threshold value (“Yes” in Step S420), in Step S430, the moving picture data transmission apparatus 100A adds the FEC code to the IP packet.

In Step S440, the moving picture data transmission apparatus 100A transmits the IP packet to the moving picture data transmission apparatus 200 of a reception side.

If the macroblock importance is equal or less than the predetermined threshold value (“No” in Step S420), the moving picture data transmission apparatus 100A transmits the IP packet to the moving picture data transmission apparatus 200 of a reception side without adding the FEC code to the IP packet.

(Effects and Advantages)

In the above described moving picture data transmission apparatus 100A and moving picture data transmission apparatus 200 according to the this embodiment, only when a macroblock importance (a specific macroblock importance) of a lost IP packet exceeds the predetermined threshold value, retransmission of the lost IP packet is requested. In other words, retransmission of an IP packet containing macroblocks which are not so important in replaying moving picture data is not requested. Therefore, the moving picture data transmission apparatus 200 can execute a decoding process of macroblocks at a higher speed.

Furthermore, since retransmission of the foregoing IP packet is not requested, it is possible to reduce an amount of IP packets transmitted and received through the communication network 10. In particular, because a loss of an IP packet tends to occur when the communication network 10 is congested, a reduction in the number of retransmitted IP packets contributes to improvement in congestion in the communication network 10.

According to this embodiment, a macroblock importance can be transmitted by an IP packet (the IP packet P12 shown in FIG. 18) different from an IP packet containing macroblocks.

Accordingly, in a case where a moving picture data transmission apparatus of a reception side is capable of executing the processes using macroblock importance contained in the IP packet (the IP packet P12). On the other hand, in a case where the moving picture data transmission apparatus of a reception side is not capable of executing the processes, the IP packet containing the macroblocks has no difference from a conventional IP packet containing macroblocks, and therefore, the moving picture data transmission apparatus can be operated normally.

Furthermore, as shown in FIGS. 19B and 19C, a macroblock importance of macroblocks contained in the IP packet P23 (or the IP packet P21) transmitted after (or before) the IP packet P22 can be transmitted by including the macroblock importance in the IP packet P22.

Accordingly, even when a specific IP packet has been lost, a macroblock importance of the lost IP packet can be immediately recognized.

According to this embodiment, if a macroblock importance is equal or less than a predetermined threshold value, at least a part of decoding process of the macroblocks is omitted. Accordingly, the decoding process can be executed at a higher speed. Particularly in a case where the decoding processing is executed by software, a load imposed on a CPU can be reduced, and also, decoding process of moving picture data, which is likely to delay more often than decoding process of audio data, can be more reliably executed.

According to this embodiment, if a macroblock importance of macroblocks is equal or less than a predetermined threshold value, addition of the FEC code is omitted. Accordingly, an amount of data transmitted through the communication network can be reduced while maintaining error resistance of important macroblocks.

### Other Embodiments

As mentioned above, while a content of the present invention has been disclosed by way of one embodiment of the present invention, it should not be understood that these statements and drawings constituting a part of the disclosure limit the present invention. Based on this disclosure, various alternative embodiments will be obvious to those skilled in the art.

For example, the abovementioned motion vector calculator 103, the reference picture block determiner 105, the weight assigner 107 and the communication unit 109 (excluding a hardware part constituting a LAN interface) can be provided as computer programs executable on a personal computer or the like.

In the first and second embodiments, the moving picture data transmission apparatus 100A and the moving picture data transmission apparatus 200 are connected to each other through the communication network 10. However, it is not necessarily required that the moving picture data transmission apparatus 100A and the moving picture data transmission apparatus 200 be connected to each other through the communication network 10, and it is also possible to assume a configuration where they are connected through a communication cable or the like.

Additionally, the IP packet P12 (refer to FIG. 18) may be transmitted through a communication network different from the communication network 10 through which IF packets containing macroblocks are transmitted.

The above described first and second embodiments have a configuration where macroblocks are formed into IP packets. However, the macroblocks may be transmitted as another configuration (for example, ATM cells).

Furthermore, the second embodiment has a configuration where the FEC code is used as the error correction code. In place of the FEC code, another error correction code such as a CRC can be used.

Thus, it is needless to say that the present invention includes various embodiments and the like which are not described herein. Accordingly, the technical scope of the present invention should be defined only by invention specifications according to the scope of claims, the invention specifications being appropriate in accordance with the abovementioned descriptions.

What is claimed is:

1. A moving picture data transmission apparatus comprising:
a motion vector calculator configured to calculate a motion vector of a backward macroblock based on positions of a reference picture element on a first picture frame and of the backward macroblock containing the reference picture element on a second picture frame reproduced after the first picture frame;
a reference picture block determiner configured to determine a reference picture block which is a region on the first picture and containing the reference picture element and based on the motion vector calculated by the motion vector calculator;
a weight assigner configured to assign a weight to a macroblock on the first picture frame in accordance with the ratio of an overlap region where the reference picture block overlaps the macroblock on a picture frame; and
a transmission method controller configured to control a transmission method of the macroblock based on the weight assigned by the weight assigner.

2. The moving picture data transmission apparatus of claim 1, wherein the weight assigner assigns the ratio of the overlap region to a region occupied by the macroblock as the weight.

3. The moving picture data transmission apparatus of claim 1, wherein the weight assigner determines the weight assigned to the macroblock by using a plurality of the reference picture blocks determined by the reference picture block determiner.

4. The moving picture data transmission apparatus of claim 1, wherein the transmission method controller transmits the macroblock toward a transmission destination more than once if a value of the weight exceeds a predetermined threshold value.

5. The moving picture data transmission apparatus of claim 1, wherein the transmission method controller transmits a packet toward a transmission destination more than once if a sum of the weights assigned to a plurality of the macroblocks contained in the packet to be transmitted exceeds a predetermined threshold value.

6. The moving picture data transmission apparatus of claim 1, wherein the transmission method controller generates a packet so as to limit a sum of the weights assigned to a plurality of the macroblocks contained in the packet to be transmitted within a predetermined range.

7. The moving picture data transmission apparatus of claim 1, wherein the transmission method controller discards the macroblock if the weight assigned to the macroblock is lower than a predetermined threshold value.

8. The moving picture data transmission apparatus of claim 1, further comprising an importance transmitter configured to transmit a macroblock importance indicating the weights assigned to the macroblocks to a destination.

9. The moving picture data transmission apparatus of claim 8, wherein
the importance transmitter includes either a macroblock importance of macroblocks contained in a forward packet which is transmitted before a packet containing the macroblock, or a macroblock importance of macroblocks contained in a backward packet which is transmitted after a packet containing the macroblock on the packet and,
the importance transmitter transmits the packet.

10. The moving picture data transmission apparatus of claim 8, wherein the importance transmitter includes the macroblock importance in a packet different from a packet containing the macroblocks and then transmits the macroblock importance.

11. The moving picture data transmission apparatus of claim 1, further comprising
a judgment unit configured to judge whether to add an error correction code to a packet based on values of the weights assigned to the macroblocks contained in the packet to be transmitted, wherein
if the judgment unit judges that the error correction code is not added to the packet, the transmission method controller transmits the packet without adding the error correction code to the packet.

12. A moving picture data transmission apparatus, comprising:
a packet reception unit configured to sequentially receive packets each containing macroblocks, in which a picture frame is divided;
an importance reception unit configured to receive a macroblock importance indicating weights assigned to the macroblocks;
an importance determiner configured to determine a specific macroblock importance of macroblocks contained in a specific packet which the packet reception unit has lost due to failure to receive; and
a retransmission request unit configured to request retransmission of the specific packet if the specific macroblock importance determined by the importance determiner exceeds a predetermined threshold value.

13. The moving picture data transmission apparatus of claim 12, wherein
the specific macroblock importance is contained in either a forward packet received before the specific packet and a backward packet received after the specific packet, and
the importance determiner determines the specific macroblock importance by using the specific macroblock importance contained in either the forward packet or the backward packet.

14. A moving picture data transmission apparatus, comprising:
a packet reception unit configured to sequentially receive packets each containing macroblocks, in which a picture frame is divided;
a decoding processor configured to execute a decoding process of the macroblocks received by the packet reception unit; and
an importance reception unit configured to receive a macroblock importance indicating weights assigned to the macroblocks, wherein
if the macroblock importance received by the importance reception unit is equal or less than a predetermined threshold value, the decoding processor omits at least a part of the decoding process.
